(19) United States
(12) Patent Application Publication
(10) Pub. No.: US 2024/0260146 A1
(43) Pub. Date: Aug. 1, 2024

(54) COOKING APPLIANCE DOUBLING AS HOOD

(71) Applicant: LG Electronics Inc., Seoul (KR)

(72) Inventors: Sangcheol LEE, Seoul (KR); Kyoung-Joon PARK, Seoul (KR); Jaekyung YANG, Seoul (KR); Wontae KIM, Seoul (KR)

(73) Assignee: LG Electronics Inc., Seoul (KR)

(21) Appl. No.: 18/290,434

(22) PCT Filed: May 31, 2021
(86) PCT No.: PCT/KR2021/006749

§ 371 Date: Nov. 13, 2023

(30) Foreign Application Priority Data
May 12, 2021 (KR) 10-2021-0061463

(51) Int. Cl. H05B 6/64; F24C 15/20

(52) U.S. Cl. CPC H05B 6/6423; F24C 15/2042; H05B 6/6414

(57) ABSTRACT

A cooking appliance including a door, a display, a camera, and a blower module disposed inside the door to cool the electrical components and creating an air flow that functions as an air curtain and is separate from an air flow path suctioning contaminants, to prevent the contaminants from adhering to the display and the camera.

### TECHNICAL FIELD

The present disclosure relates to a cooking appliance having a hood function, and in particular, a cooking appliance doubling as a hood, in which a blower module is disposed in a door, cools electrical components such as a display, a camera and the like provided at the door to prevent thermal damage to the electrical components effectively, allows airflow, which is discharged after the airflow is used to cool the electrical components, to act as an air curtain to prevent contaminants from being fixed to the display and the camera and the like effectively.

### BACKGROUND ART

Cooking appliances are installed in the kitchen and used to cook food items as the user wants. Cooking appliances can fall into different categories, based on a heat source or the type of a cooking apparatus, and the sort of fuel.

Cooking appliances can be categorized into open-type cooking appliances and sealed-type cooking appliances, depending on the shape of a space where a food item is placed. A sealed-type cooking appliance comprises an oven, a microwave oven and the like, and an open-type cooking appliance comprises a cooktop, a hob and the like.

Among sealed-type cooking appliances, a microwave oven doubling as a hood serves as a hood disposed over a cooktop and configured to suction and discharge contaminated air including contaminants such as a smell or a smoke and the like generated from the cooktop as well as a microwave oven performing cooking.

Ordinarily, a microwave oven doubling as a hood is installed over a cooktop and spaced a predetermined distance apart from the cooktop. The microwave oven doubling as a hood serves as a hood performing functions of suctioning contaminated air including contaminants such as a smell or a smoke and the like generated and moved upward from the kooktop disposed under the microwave oven and discharging the contaminated air outward, as well as a microwave oven performing an ordinary cooking function as a cooking appliance.

As a related art, a microwave oven doubling as a hood provided with an air filter that filters contaminants included in contaminated air and is provided in a suction opening formed on the lower surface of a main body is disclosed in KR Patent Publication No. 10-2013-0071557.

In the structure according to the document, the air filter is readily detached and attached based on a simple manipulation of the user.

However, in the microwave oven doubling as a hood according to the document, the air filter is gradually blocked while the food is used.

Unless the air filter is replaced or cleaned periodically, contaminated air generated from below is not discharged effectively through the suction opening.

In the case where the contaminated air generated from the cooktop is not discharged effectively, the contaminants included in the contaminated air move up and adhere to the surface of the microwave oven.

In particular, in the case where contaminants such as oil most and fine dust and the like included in contaminated air are fixed to the surface of the microwave oven, causing the user unpleasant feeling and causing a hygienic problem.

Further, in the case where contaminants are fixed to the surface of a transparent plate through which the inside of the cooking compartment is seen, it is difficult for the user to check the cooking state of a food item in the cooking compartment while the microwave oven operates, causing inconvenience to the user.

### DESCRIPTION OF THE INVENTION

### Technical Problems

The first objective of the present disclosure is to provide a cooking appliance doubling as a hood, in which a plurality of electrical components for improving user convenience is built in, and the plurality of electrical components cools effectively with external air, thereby effectively preventing damage to electrical components of the door, caused by high-temperature heat generated from a cooking compartment.

The second objective of the present disclosure is to provide a cooking appliance doubling as a hood, in which an airflow of external air used to cool the electrical components of the door is used as an air curtain, to prevent contaminants included in contaminated air from adhering to the outer surface of the door or a display module and the like, thereby improving user convenience and preventing the contaminants from flowing into the door.

Aspects according to the present disclosure are not limited to the above ones, and other aspects and advantages that are not mentioned above can be clearly understood from the following description and can be more clearly understood from the embodiments set forth herein. Additionally, the aspects and advantages in the present disclosure can be realized via means and combinations thereof that are described in the appended claims.

### Technical Solutions

A cooking appliance doubling as a hood, according to the present disclosure, comprises a main body provided with a cavity which has a cooking compartment therein and a front surface of which is open, and an air flow path into which contaminated air including contaminants generated in the downward direction is suctioned and flows and which is formed around the cavity, and a door disposed swivably on the front surface of the main body, wherein the door is provided with a blower module configure to draw external air into the door from above. Accordingly, thermal damage to electrical components sitting in the door form the cavity is minimized, and the electrical components cool effectively.

The contaminated air is suctioned into a lower surface of the main body, and the external air is suctioned into an upper surface of the door.

The door comprises a main frame shaped into a box a rear surface of which is open, and a rear frame which is coupled to the open rear surface of the main frame and has a planar shape, wherein the blower module is accommodated between the main frame and the rear frame, and fixed to the rear frame.

The blower module comprises a suction duct provided with at least one of inlets into which the external air is drawn, and an air flow path in which the external air flows therein, and at least one of air blowing fans supported in the suction duct, and configured to suction the external air and generate an air flow of the external air, wherein the suction duct is fixed to a front surface of the rear frame.

The door further comprises a shielding plate fixed to the rear frame and assembled to an open front surface of the cavity, the suction duct covers a front surface of the shielding plate at least partially, and the shielding plate is at least partially exposed to external air flowing in the air flow path.

The suction duct is provided with at least one of outlets through which external air drawn through the inlet is discharged, and at least one of the outlets is open toward a front surface of the main frame.

The door is provided with a cooking compartment camera photographing the cooking compartment, and the cooking compartment camera is disposed in the air flow path, and exposed to an airflow of external air flowing in the air flow path.

The cooking compartment camera is fixed to an inner surface of the suction duct.

At least one of the inlets comprises a first inlet and a second inlet spaced from each other in the left-right direction, and the door is provided with a front camera disposed between the first inlet and the second inlet, and configured to photograph a front of the door.

The front camera is disposed on a front surface of the main frame, and exposed to an airflow of the external air.

The door is provided with a display module disposed at a front of a front surface of the main frame, an open part is provided on the front surface of the main frame and exposes a rear surface of the display module at least partially toward the blower module, and the rear surface of the display module is exposed at least partially to an airflow of the external air through the open part.

The door is provided with a first exhaust opening which is formed at a lower side of the display module and through which an airflow of the external air is discharged outward, and the airflow of the external air is discharged in a direction across a direction in which the contaminated air moves up while passing through the first exhaust opening.

The first exhaust opening is formed under a front surface of the main frame in a slip shape extending along the left-right direction, and a left-right length of the first exhaust opening is greater than a left-right width of the display module.

The door is provided with a second exhaust opening which is formed at an upper side of the display module and through which an airflow of the external air is discharged outward, and the airflow of the external air is discharged in a direction across a direction in which the contaminated air moves up, while passing through the second exhaust opening.

The door is provided with a guard plate disposed at a front of the second exhaust opening and configured to change a direction in which the airflow of the external air discharged to the second exhaust opening proceeds, and the airflow of the external air, a direction of which is changed by the guard plate, flows downward in parallel with the display module.

The front camera is disposed at a rear of the guard plate, and the front camera is exposed to the airflow of the external air to be discharged to the second exhaust opening.

The door is provided with a lower camera photographing the downward direction of the door, and the lower camera is supported by a lower surface of the main frame and exposed to the airflow of the external air.

The door is provided with a third exhaust opening which is formed at a lower side of the lower camera and through which the airflow of the external air is discharged outward, and the lower camera is exposed to an airflow of the external air to be discharged to the third exhaust opening.

The door is provided with a camera holder supporting the lower camera, and the camera holder is formed apart from the main frame and fixed to the lower surface of the main frame.

The camera holder is provided with a through hole through which the airflow of the external air passes, the third exhaust opening is formed on the lower surface of the main frame, at a lower side of the through hole, and an airflow of the external air having passed through the through hole is discharged to the third exhaust opening.

The door is provided with a camera holder supporting the lower camera, and the camera holder is integrally formed on the lower surface of the main frame.

### Advantageous Effects

In a cooking appliance doubling as a hood according to the present disclosure, a plurality of electrical components for improving user convenience is built in, and the plurality of electrical components cools effectively with external air, thereby effectively preventing damage to electrical components of the door, caused by high-temperature heat generated from a cooking compartment.

In the cooking appliance doubling as a hood according to the present disclosure, an airflow of external air used to cool the electrical components of the door is used as an air curtain, to prevent contaminants included in contaminated air from adhering to the outer surface of the door or a display module and the like, thereby improving user convenience and preventing the contaminants from flowing into the door.

Specific effects are described along with the above-described effects in the section of detailed description.

### BRIEF DESCRIPTION OF THE DRAWINGS

FIG. 1 is a front perspective view showing that a microwave oven doubling as a hood according to the present disclosure is installed.

FIG. 2 is a cross-sectional schematic view showing that a hood function of the microwave oven doubling as a hood according to the present disclosure is performed.

FIG. 3 is a front perspective view showing the microwave oven doubling as a hood illustrated in FIG. 1.

FIGS. 4 and 5 are front perspective views showing a door of one embodiment.

FIG. 6 is a rear perspective view showing the door of one embodiment.

FIG. 7 is an exploded perspective view showing the door of one embodiment.

FIG. 8 is a front perspective view showing a main frame illustrated in FIG. 7, and

FIG. 9 is a rear perspective view showing the main frame illustrated in FIG. 7.

FIGS. 10 and 11 are exploded perspective views showing a blower module, a rear frame and a shielding plate illustrated in FIG. 7.

FIG. 12 is an exploded perspective view showing that the blower module illustrated in FIGS. 10 and 11 is disposed at a main frame.

FIGS. 13 and 14 are a front perspective view and an exploded perspective view showing a lower camera module illustrated in FIG. 7.

FIG. 15 is a cross-sectional view showing that the door of one embodiment is cut along line A-A in FIG. 6.

FIGS. 16 and 17 are partially enlarged views of FIG. 15.

### DETAILED DESCRIPTION OF EXEMPLARY EMBODIMENTS

The above-described aspects, features and advantages are specifically described hereinafter with reference to accompanying drawings such that one having ordinary skill in the art to which the subject matter of the present disclosure pertains can embody the technical spirit of the disclosure easily. In the disclosure, detailed description of known technologies in relation to the subject matter of the disclosure is omitted if it is deemed to make the gist of the disclosure unnecessarily vague. Hereinafter, preferred embodiments according to the disclosure are specifically described with reference to the accompanying drawings. In the drawings, identical reference numerals can denote identical or similar components.

The terms “first”, “second” and the like are used herein only to distinguish one component from another component. Thus, the components are not to be limited by the terms. Certainly, a first component can be a second component, unless stated to the contrary.

Throughout the disclosure, each component can be provided a single one or a plurality of ones, unless stated to the contrary.

When any one component is described as being “in the upper portion (or the lower portion)” or “on (or under)” another component, any one component can be directly on (or under) another component, and an additional component can be interposed between the two components.

When any one component is described as being “connected”, “coupled” or “connected” to another component, any one component can be directly connected or coupled to another component, but an additional component can be “interposed” between the two components or the two components can be “connected”, “coupled” or “connected” by an additional component.

In the disclosure, singular forms include plural forms as well, unless explicitly indicated otherwise. In the disclosure, the terms “comprised of”, “comprise”, and the like do not imply necessarily including stated components or stated steps and imply excluding some of the stated components or stated steps or including additional components or additional steps.

In the disclosure, singular forms include plural forms as well, unless explicitly indicated otherwise. In the disclosure, the terms “comprised of”, “comprise”, and the like do not imply necessarily including stated components or stated steps and imply excluding some of the stated components or stated steps or including additional components or additional steps.

Throughout the disclosure, the terms “A and/or B” as used herein can denote A, B or A and B, and the terms “C to D” can denote C or greater and D or less, unless stated to the contrary.

Hereinafter, the present invention is described with reference to drawings where the configurations of cooking appliances in embodiments of the present disclosure are illustrated.

### [Entire Structure of Cooking Appliance]

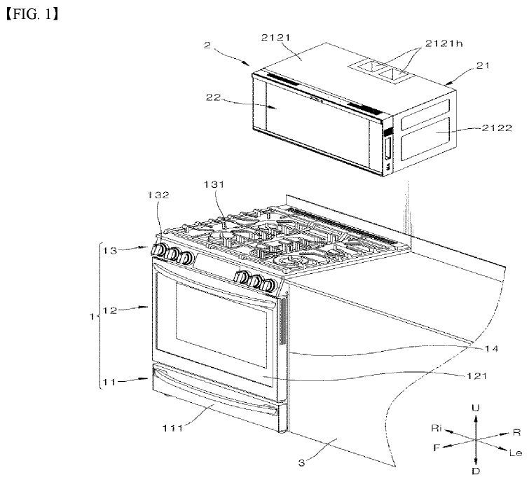

FIG. 1 is a perspective view showing cooking appliances of one embodiment.

As illustrated in FIG. 1, a plurality of cooking appliances may be installed at one side of a kitchen.

The plurality of cooking appliances may comprise an oven range 1 that is disposed on the upper surface of furniture provided in a kitchen or is installed solely, as a cooking appliance, to heat a food item by using gas.

The oven range 1 may comprise an oven range main body 14 that forms the exterior of the oven range 1 and is built in, together with a sink 3 and the like, in an indoor space, an oven part 12 that is formed approximately in a central portion of the oven range main body, a range that is provided at the upper side of the oven part 12, and a drawer part 11 that is formed at the lower side of the oven part 12.

Specifically, the oven part 12 may have a cavity (not illustrated) therein. An oven door 121 that is opened and closed based on a selection of the user may be swivably coupled to the front surface of the cavity. The oven part 12 may cook a food item that is accommodated in the cavity through a heater (not illustrated) and a convection heating part (not illustrated) and the like which are provided in the cavity.

The drawer part 11 may comprise a drawer 111 that is accommodated in the oven range main body 14 in a sliding manner, and a heater (not illustrated) that is disposed at the lower side of the drawer part 11. Accordingly, as the lower surface of the drawer 111 is heated, a food item accommodated in the drawer 111 may be cooked.

The range 13 may comprise a plurality of burners 131 that is formed on the upper surface of the range 13 and functions as a cooktop, a gas supply pipe (not illustrated) that is provided in the range 13 and supplies gas to the plurality of burners 131, and a plurality of manipulation knobs 132 that is formed on the front surface of the range 13 and controls an operation of the range 13.

Accordingly, in a state where a cooking container containing a cooking target is disposed on the plurality of burners 131, gas drawn via the gas supply pipe lights a fire on the plurality of burners 131, such that the food item contained in the cooking container is heated and cooked.

FIG. 1 shows that the burner 131 is provided as a cooktop of the range 13 and uses the combustion energy of gas, for example, but not limited in the present disclosure, and another type of heat source is available and applicable. That is, an electric heating method using an electrothermal wire, and an induction heating method using an induction coil are also applicable. Hereinafter, a burner-type cooktop using the combustion energy of gas is described for convenience.

Additionally, a microwave oven 2 (hereinafter, a microwave oven doubling as a hood) may be installed on a wall W, in the upward direction of the cooktop of the range 13, as a cooking appliance doubling as a hood.

The microwave oven 2 according to the present disclosure may perform a hood function of suctioning air (hereinafter, contaminated air) including contaminants produced while the cooktop under the microwave oven 2 cooks a food item, and discharging the contaminated air to an outdoor space or purifying the contaminated air and discharge the purified air to an indoor space, as well as performing a cooking function of heating and cooking a food item with microwaves and/or the heat of a heater.

A publicly-known configuration in the art is applicable to the cooking function of the microwave oven 2, and each component for the cooking function, and detailed description in relation to this is omitted.

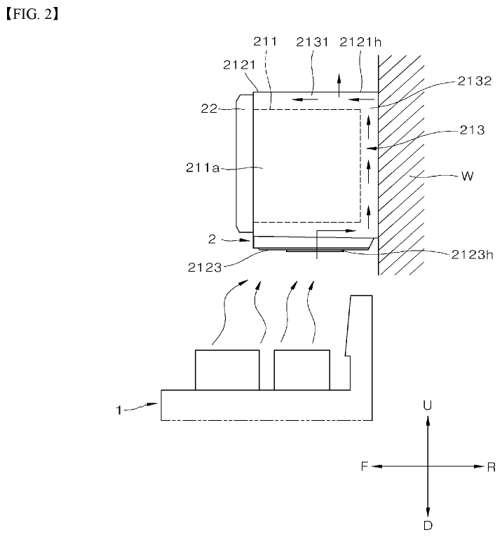

As illustrated in FIG. 2, the microwave oven 2 may comprise a main body 21 provided with a cavity 211 that has a cooking compartment 211a, in which a cooking target is cooked, therein.

The cavity 211 is accommodated in the main body 21, and preferably, accommodated in an outer case 212 of the main body 21.

The outer case 212 may comprise an upper case 2121 forming an upper exterior of the outer case, a side case 2122 forming a lateral exterior of the outer case, and a lower case 2123 forming a lower exterior of the outer case.

Additionally, at least any one of a high-frequency heating source, a radiation hearing source and a convection heating source may be provided in the outer case 212, as a heating source for cooking a cooking target in the cooking compartment 211a.

Further, a main body air flow path 213 for embodying a hood function may be provided around the cavity 211, in the outer case 212. Specifically, the main body air flow path 213 may be provided in the outer case 212 and comprise an outdoor discharge flow path 2132 for discharging contaminated air suctioned through a main body inhale opening 2123h to an outdoor space, and an indoor discharge flow path 2131 for purifying contaminated air and discharging the purified air to an indoor space. As illustrated in FIG. 2, the main body inhale opening 2123h may be formed at the lower case 2123.

Further, a filter (not illustrated) for removing contaminants included in the contaminated air may be provided on the indoor discharge flow path 2131.

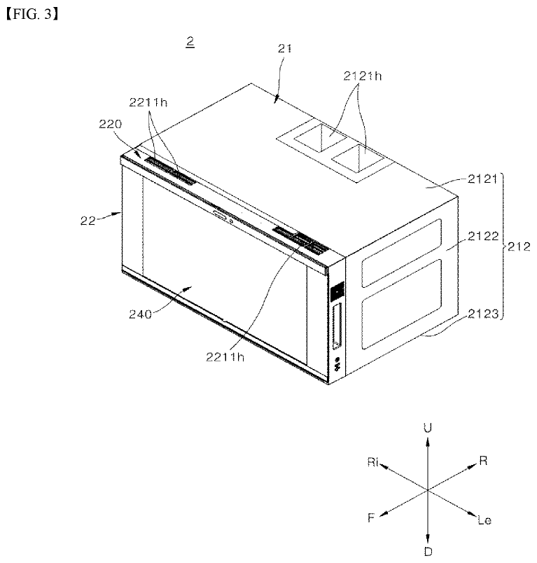

Furthermore, a vent fan (not illustrated) may be provided in the outer case 212. The vent fan forms the airflow of air that is suctioned through the main body inhale opening 2123h, flows in the outdoor discharge flow path 2132 or the indoor discharge flow path 2131 and is discharged to an outdoor space or an indoor space. The outdoor discharge flow path 2131. Contaminated air flowing in the outdoor discharge flow path 2132 is discharged outward through a main body exhaust opening (2121h in FIG. 3). For example, the main body exhaust opening 2121h may be formed at the upper case 2121.

The configuration of any microwave oven 2 doubling as a hood, which has been already known in the art, is applicable to the outdoor discharge flow path 2132, the indoor discharge flow path 2131, the filter and the vent fan, described above, and therefore, detailed description in relation to this is omitted hereinafter.

### [Entire Structure of Door of Microwave Oven Doubling as Hood]

Additionally, the microwave oven doubling as a hood 2 according to the present disclosure may be provided with a door 22 for selectively opening and closing the cooking compartment 211a.

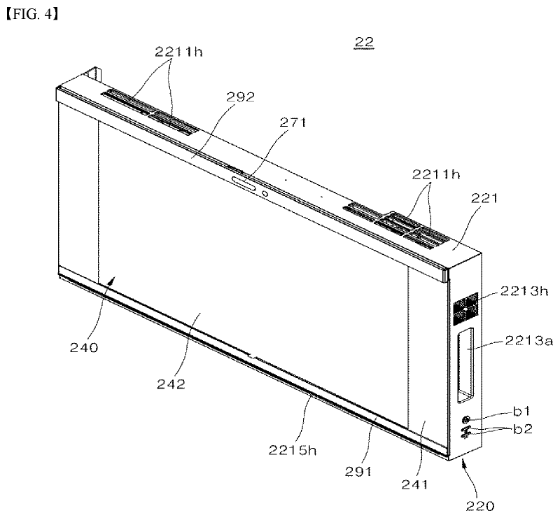

As illustrated in FIGS. 3 to 6, the door 22 of the microwave oven 2 doubling as a hood may be shaped into a cuboid where a predetermined front-rear (F-R direction) size is much less than an up-down (U-D direction) height and a left-right (Le-Ri direction) width.

However, unlike an existing door, the door 22 of one embodiment is structured to accommodate members performing other functions additionally in addition to the function of opening and closing the cooking compartment 211a simply, such that the front-rear size of the door is slightly greater than that of an existing door.

The door 22 may swivably connect to the front of the cavity 211, to selectively open and close the cooking compartment 211a of the cavity 211 disposed rearward.

The door 22 may be provided rotatably in the up-down direction (U-D direction), or provided rotatably in the left-right direction (Le-Ri direction). In the case where the door rotates in the up-down direction, a rotation center may be formed on a left-right axis, and in the case where the door rotates in the left-right direction, a rotation center may be formed on an up-down axis, but not limited in the present disclosure. Hereinafter, a configuration in which the door 22 is provided in such a way that the door 22 rotates in the up-down direction is described for convenience.

A hinge (not illustrated) may be provided between the door 22 and the main body 21 and connect the door 22 to the main body 21 and supports the door 22 in such a way that the door 22 is rotatable in the up-down direction.

A grip groove 2213a serving as a handle to be gripped by the user may be concavely provided on the left surface of the door 22.

Additionally, a display module 240 displaying a predetermined image may be disposed on the front surface of the door 22.

The door 22 of one embodiment may be disposed in such a way that the display module 240 forms all or part of the outer surface of the front of the door 22. In FIGS. 1 to 3, the display module 240 displaying an image forms part of the outer surface of the front of the door 22, for example, but is not limited in the present disclosure. However, the illustrated embodiment is described.

An image displayed on the display module 240 constituting the outer surface of the front of the door 22 may comprise an image of the inside of the cooking compartment 211a, an image of the front of the door 22, and an image of the downward direction (D-direction) of the door 22.

As a means of producing such images, the door 22 of one embodiment may comprise a camera module 270. Specifically, the camera module 270 may comprise a cooking compartment camera module 273 photographing the inside of the cooking compartment 211a, a front camera module 271 photographing the front of the door 22, and a lower camera module 272 photographing the downward direction of the door 22.

Images photographed by the cooking compartment camera module 273, the front camera module 271 and the lower camera module 272 may be transmitted to the display module 240 in a wired or wireless manner, and displayed through the display module 240.

Further, the door 22 of one embodiment may be configured such that images photographed by the cooking compartment camera module 273, the front camera module 271 and the lower camera module 272 are transmitted to a mobile device of the user. Additionally, the door may be configured such that the user controls the microwave oven 2 doubling as a hood remotely through the mobile device.

By doing so, the user may monitor and check a situation where a food item is cooked in the cooking compartment 211a, a situation at the front of the door 22, and a situation where a food item is cooked at the cooktop under the door 22, in real time. Thus, while the user is away, the user remotely monitors a situation in the cooking compartment 211a, and a situation of the cooktop and controls the microwave oven 2, in real time, enhancing user convenience significantly.

Additionally, each of the cooking compartment camera module 273, the front camera module 271 and the lower camera module 272 may be installed and supported in the door 22. Detailed description in relation to them is provided hereinafter with reference to FIGS. 1 to 7.

Further, the display module 240 of the door 22 of one embodiment may be configured to sense a touch input of the user. To this end, the frontmost surface of the display module 240 may be configured as a touch screen or a touch plate 241.

Further, the door 22 may have a speaker module 250 generating an alarm sound or a guide sound, therein. In the illustrated embodiment, a first speaker 251 is installed inside the left surface of the door 22, and a second speaker 252 is installed inside the rear surface of the door 22. A speaker hole 2212h, 2213h may be formed respectively in the position where the first speaker 251 is installed and the position where the second speaker 252 is installed, such that an alarm sound or a guide sound generated through the first speaker 251 and the second speaker 252 is delivered readily to the outside. As illustrated, a speaker hole 2213h in which the first speaker 251 is installed may be formed at the upper side of the grip groove 2213a, for example.

Additionally, a power button b1 and a selection button b2 constituting a physical button part may be provided at the lower side of the grip groove 2213a, on the left surface of the door 22.

Further, the door 22, as described above, opens and closes the front surface of the cooking compartment 211a that is open. As a means of minimizing a leakage of electromagnetic waves or high-temperature heat generated in the cooking compartment 211a to the outside, a shielding plate 230 made of metal may be provided.

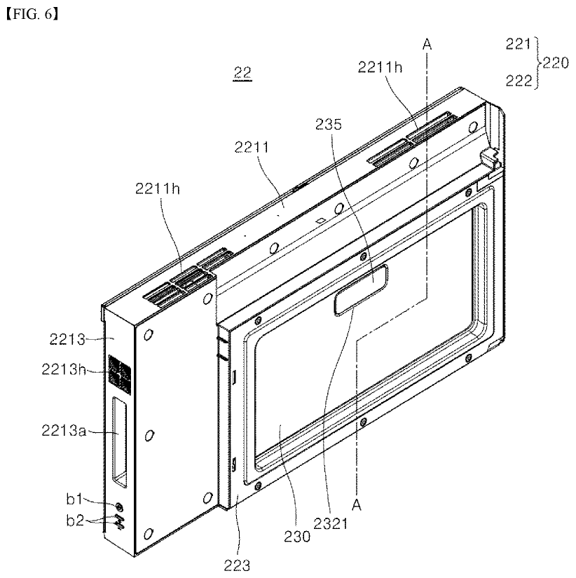

As illustrated in FIG. 6, the shielding plate 230 forms part of the rear surface of the door 22, and directly shields the open front surface of the cooking compartment 211a.

As described hereinafter, a plurality of electrical components such as a display module 240, a control module, a camera module and a speaker module 250 and the like are accommodated and disposed in the door 22.

The electrical components are easily damaged or broken by electromagnetic waves and high-temperature heat generated in the cooking compartment 211a. The shielding plate 230 may minimize an amount of electromagnetic waves and high-temperature heat delivered to the electrical components, and minimize damage to the electrical components. In particular, the shielding plate 230 may serve as a primary means of protecting the electrical components from high-temperature heat.

Further, the shielding plate 230 may have a penetration hole 2321 for ensuring a visual field of the above-described coming compartment camera 2731, and a heat insulation glass 235 for protecting the cooking compartment camera 2731 from high-temperature heat of the cooking compartment 211a may be disposed in the penetration hole 2321.

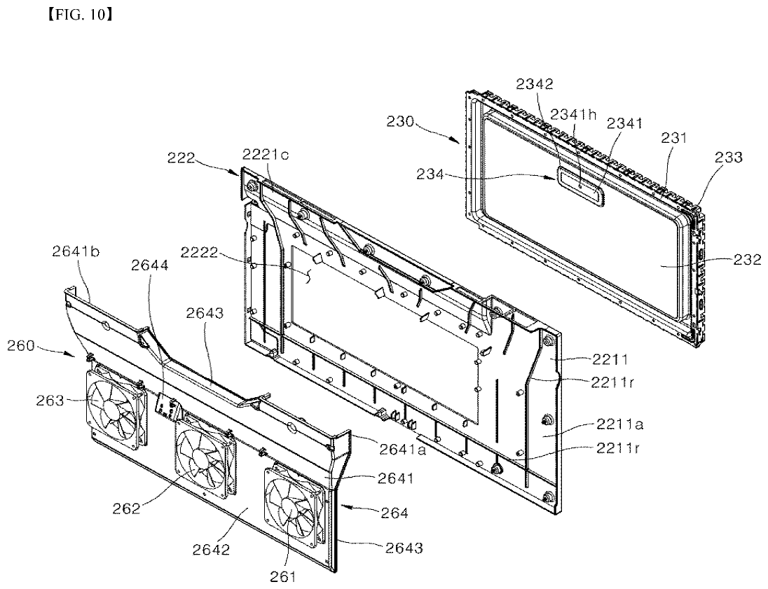

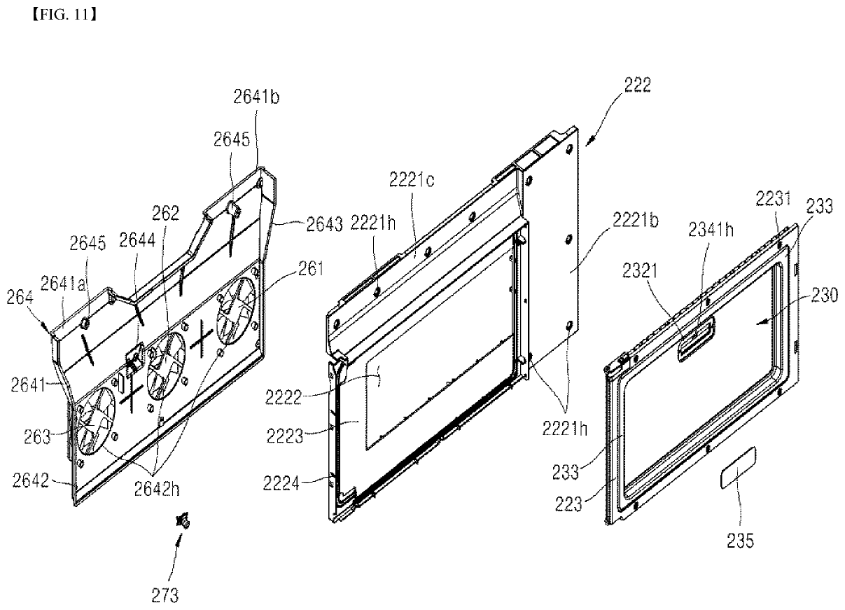

A detailed configuration of the shielding plate 230 is described hereinafter, with reference to FIGS. 10 and 11.

Further, the door 22 of one embodiment is provided with a blower module 260 as a secondary means of protecting the electrical components accommodated in the door 22 from high-temperature heat, and the blower module 260 draws external air into the door 22.

As described hereinafter, the blower module 260 is disposed in the door 22 and configured to suction external air into the door 22 and blow air.

With the external air suctioned and blown, heat insulation is ensured not to allow high-temperature heat to be delivered from the shielding plate 230 into the door 22, and further, with the air blown, the electrical components may be directly cooled. Accordingly, a structure capable of doubly protecting the electrical components in the door 22 from high-temperature heat may be obtained. A detailed configuration of the blower module 260 is described hereinafter with reference to FIGS. 10 to 12.

Further, external air suctioned through the blower module 260 is drawn through an inhale opening 2211h formed on the upper surface of the door 22. As described above, contaminated air including contaminants generated in the cooktop is drawn to the lower surface of the door 22 and the lower surface of the main body 21.

Accordingly, external air drawn into the door 22 needs to prevent the withdrawal of contaminants, at least, to minimize the withdrawal of contaminants. To this end, an inlet of external air drawn into the door 22 is preferably formed on the upper surface of the door 22.

As illustrated, a grille may be formed at the inhale opening to minimize the inflow of external materials. Further, an inlet of the blower module 260 described hereinafter may be formed in a corresponding position inside the inhale opening.

Further, a plurality of exhaust openings through which external air drawn into the door 22 through the blower module 260 is discharged may be formed at the door 22.

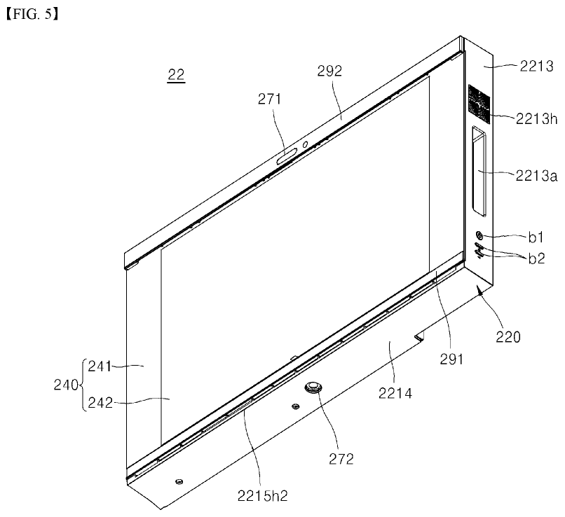

Preferably, the plurality of exhaust openings, as illustrated in FIG. 5, may comprise a first exhaust opening 2215h1 formed at the lower side of the display module 240, and a second exhaust opening 2215h2 formed at the upper side of the display module 240.

The first exhaust opening 2215h1 and the second exhaust opening 2215h2 may be formed on the front surface of the door 22 and shaped into a slit that extends linearly along the left-right direction (Le-Ri direction).

The airflow of external air discharged to the first exhaust opening 2215h1 and the second exhaust opening 2215h2 may serve as an air curtain that prevents and suppresses movement of the contaminated air described above toward the front surface of the door 22, i.e., the display module 240.

That is, the door 22 of one embodiment may use external air that is discharged after the external air cools the electrical components in the door, to minimize contamination of the display module 240 and the front surface of the door 22 caused by the contaminated air.

Further, a first guard plate 291 and a second guard plate 292 capable of changing the direction of the airflow of the external air discharged to the first exhaust opening 2215h1 and the second exhaust opening 2215h2 may be provided respectively at the front of the first exhaust opening 2215h1 and the second exhaust opening 2215h2.

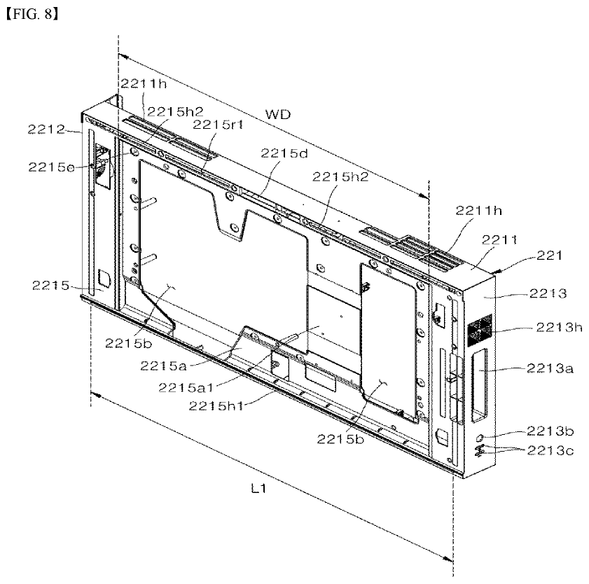

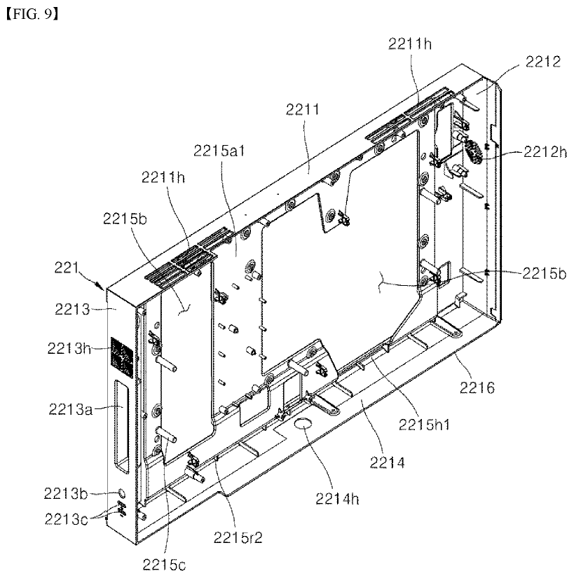

Detailed configurations of the first exhaust opening 2215h1 and the second exhaust opening 2215h2 are described hereinafter, with reference to FIGS. 8 and 9.

Additionally, the plurality of exhaust openings may further comprise a third exhaust opening 2214h that is formed on the lower surface of the door 22 and allows air to be discharged along the downward direction (D-direction). As illustrated, unlike the first exhaust opening 2215h1 and the second exhaust opening 2215h2, the third exhaust opening 2214h may be shaped into a simple circle.

At this time, the above-described lower camera module 272 may be provided at the upper side of the third exhaust opening 2214h, and a lower camera may be exposed to the airflow of external air to be discharged to the third exhaust opening 2214h. That is, the airflow of external air discharged to the third exhaust opening 2214h passes over the lower camera module 272 and then passes through the third exhaust opening 2214h, and is discharged in the downward direction (D-direction).

By doing so, the airflow of external air used for cooling the lower camera is discharged in the downward direction that is opposite to a direction in which contaminated air moves, and the airflow of external air discharged to the third exhaust opening 2214h serves as a spray hole for an air curtain that prevents contamination of the lower camera.

### [Detailed Structure of Door of Microwave Oven Doubling as Hood]

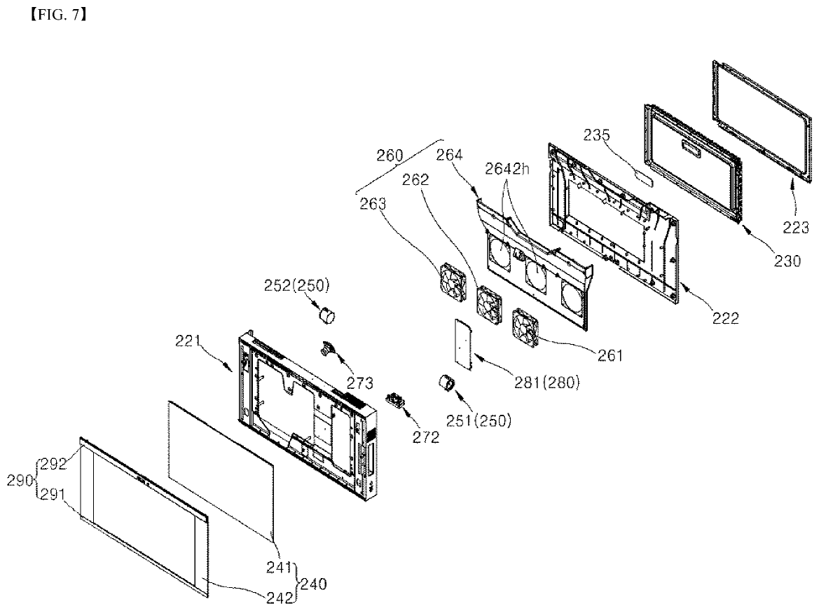

Hereinafter, a detailed structure of the door 22 of one embodiment is described with reference to FIGS. 7 to 14.

The door 22 is provided with a frame module 220 that forms an outer body and defines an accommodation space in the door 22.

For example, the frame module may comprise a main frame 221 that forms the upper surface, the lower surface and both lateral surfaces of the door 22 among the outer surfaces of the door 22, and a rear frame 222 that forms the rear surface of the door 22 among the outer surfaces of the door 22.

The subject matter of the present disclosure is not limited to the above particulars, but as illustrated, a frame module 220 comprising a main frame 221 and a rear frame 222 is described as an example.

As illustrated in FIGS. 8 and 9, the main frame 221 is shaped into a box where a rear surface 2216 is entirely open, while a front surface 2215 is partially open.

The upper surface 2211, the lower surface 2214, and the left surface 2213 and the right surface 2212 of the main frame 221 are exposed to the outside, and directly forms the outer body of the door 22.

As described above, the plurality of inhale openings 2211h into which external is drawn is formed on the upper surface 2211 of the main frame 221. Each inhale opening 2211h may have a plurality of grilles that minimizes the inflow of foreign materials.

A first inlet 2641a and a second inlet 2641b of a suction duct 264 described hereinafter directly connect to the inside of the lower portion of the plurality of inhale openings 2211h.

The plurality of inhale openings 2211h is formed in such a way that the inhale openings 2211h are spaced a predetermined distance apart from each other along the left-right direction (Le-Ri direction), and the front camera module 271 is installed between the inhale openings 2211h.

For example, the front camera module 271 may be installed in a camera hole 2215d that is formed between the two second exhaust openings 2215h2 separating in such a way that the two second exhaust openings 2215h2 are adjacent to each other, on the upper surface 2211 of the main frame 221.

Additionally, a small width surface that is relatively narrow at least partially is provided on the upper surface 2211 of the main frame 221. The rear side of the small width surface forms a space into which external air to be drawn into the above-described main body 21 flows.

A speaker hole 2213h, a grip groove 2213a, a power button hole 2213b and a selection button hole 2213c may be formed consecutively from the upper side to the lower side of the left surface 2213 of the main frame 221, on the left surface 2213 thereof.

The first speaker 251 may be installed and supported inside the speaker hole 2213h.

Additionally, the power button b1 and the selection button b2 may be installed and supported inside the power button hole 2213b and the selection button hole 2213c.

Further, a speaker hole 2212h may be formed on the right surface 2212 of the main frame 221 in a similar way to the left surface 2213. The second speaker 252 may be installed and supported inside the speaker hole 2212h.

Since a configuration publicly known in the art is unlimitedly applicable to the configurations of the first speaker 251, the second speaker 252, the power button b1 and the selection button b2, detailed description of their configurations is omitted hereinafter.

The third exhaust opening 2214h is formed on the lower surface 2214 of the main frame 221, in such a way that the third exhaust opening 2214h penetrates the lower surface 2214 and extends in the up-down direction. The third exhaust opening 2214h may be provided as a circular hole, for example.

As described above, the lower camera module 272 is disposed and supported in the upper side of the third exhaust opening 2214h. The third exhaust opening 2214h serves as a nozzle through which the airflow of external air flowing in the main frame 221 is discharged as well as ensuring a visual field of the lower camera of the lower camera module 272.

Additionally, the above-described display module 240 is disposed on the front surface 2215 of the main frame 221, and the front surface 2215 of the main frame 221 may be covered mostly by the display module 240.

The front surface 2215 of the main frame 221 has a step surface to have a shape corresponding to the shape of the rear surface of the display module 240 disposed on the front surface 2215 of the main frame 221.

A support surface 2215a to which the display 242 disposed behind the touch plate 241 is fixed is concave further rearward than a support surface 2215a to which the touch plate 241 formed at a frontmost position is fixed. The shape and disposition of the support surfaces 2215a may be adjusted to correspond to the shape of the touch plate 241 and the display 242.

Further, a plurality of fastening holes 2215e through which a fastening means such as a bolt and the like passes and extends may be formed on the support surface 2215a to which the display 242 is fixed.

Further, the front surface 2215 of the main frame 221 functioning as the support surface 2215a may be provided with a plurality of open parts 2215b that is at least partially open rearward.

That is, the rear surface of the display 242 may be at least partially exposed to the accommodation space in the door 22 through the open part 2215b. As described above, the blower module 260 is used to form the airflow of external air in the accommodation space inside the door 22. The rear surface of the display 242 is exposed directly to the airflow of external air through the open part 2215b, ensuring improvement in efficiency of cooling the display 242.

The shape of the open part 2215b and the shape of the support surface 2215a may be adjusted and applied depending on the disposition of other components except for the display 242 and a support structure.

In particular, as illustrated in FIGS. 8 and 9, a circuit board 281 on which a plurality of circuit components sit may be installed and supported at the rear of the support surface 2215a formed between the two open parts 2215b. Accordingly, the support surface 2215a formed between the two open parts 2215b may also be referred to as a board installation surface 2215a1.

The circuit board 281 and the plurality of circuit components disposed on the board installation surface 2215a1 together with the rear surface of the display 242 are directly exposed to the airflow of external air, improving cooling efficiency and preventing thermal damage to the circuit components effectively.

Further, the suction duct 264 of the blower module 260 described hereinafter is fixed to the rear surface of the support surface 2215a while the suction duct 264 keeps a predetermined distance from the rear surface of the support surface 2215a. A plurality of support bosses 2215c protruding from the rear surface of the support surface 2215a may be provided as a means of supporting the suction duct 264 while a distance between the support surface 2215a and the suction duct 264 is maintained.

Further, the first exhaust opening 2215h1 may be formed at the lower side of the display module 240, on the front surface 2215 of the main frame 221.

The first exhaust opening 2215h1 may be provided in the lower portion of the front surface 2215 of the main frame 221 in the form of a slit that extends linearly in the left-right direction.

The shape of the first exhaust opening 2215h1 may be determined such that the airflow of external air discharged to the first exhaust opening 2215h1 may have directionality across a direction in which contaminated air moves up.

That is, the airflow of the external air discharged to the first exhaust opening 2215h1 mostly has directionality facing the forward direction.

By doing so, the airflow of the external air discharged to the first exhaust opening 2215h1 may act as an air curtain that prevents and suppresses movement of contaminated air to the front surface of the display module 240, i.e., the front surface of the door 22.

To effectively function as an air curtain that prevents the contamination of the front surface of the display module 240, a left-right length L1 of the first exhaust opening 2215h1 may be at least greater than a left-right width WD of the display 242 of the display module 240.

Preferably, the left-right length L1 of the first exhaust opening 2215h1 may be also determined such that the lower portion of the touch plate 241 of the display module 240 may be covered entirely.

In the illustrated embodiment, the left-right length L1 of the first exhaust opening 2215h1 almost corresponds to the left-right width of the touch plate 241.

Additionally, to maintain the shape of the first exhaust opening 2215h1 elongated in the left-right direction, the first exhaust opening 2215h1 may be provided with a plurality of reinforcement ribs 2215r2 that extends in the up-down direction.

Further, the second exhaust opening 2215h2 may be formed at the upper side of the display module 240, on the front surface 2215 of the main frame 221.

Like the first exhaust opening 2215h1, the second exhaust opening 2215h2 may be provided in the upper portion of the front surface 2215 of the main frame 221, in the form of a slit that extends linearly along the left-right direction. However, for the camera hole 2215d for installing the front camera module 271 to be disposed as described above, the second exhaust opening 2215h2 may be formed in such a way that the second exhaust openings 2215h2 separate with the camera hole 2215d therebetween, as illustrated.

The shape of the second exhaust opening 2215h2 may be determined such that the airflow of external air discharged to the second exhaust opening 2215h2 may have directionality across a direction in which contaminated air moves up.

That is, the airflow of the external air discharged to the second exhaust opening 2215h2 mostly has directionality facing the forward direction.

At this time, the airflow of the external air discharged to the second exhaust opening 2215h2 is changed downward by the second guard plate 292 as described hereinafter. The airflow of the external air, the direction of which is changed, moves in parallel with the display module 240, and functions as an air curtain that covers the front surface of the display module 240 entirely. Description of the second guard plate 292 is provided hereinafter, with reference to FIGS. 1 to 15.

To maintain the shape of the second exhaust opening 2215h2 elongated in the left-right direction, a plurality of reinforcement ribs 2215r1 extending in the up-down direction may be provided at the second exhaust opening 2215h2.

Considering the above-described structure which has a rather complex shape and in which a plurality other members is installed, the main frame 221 may be formed based on a plastic injection molding method.

As illustrated in FIGS. 10 and 11, the frame module 220 may comprise a rear frame 222 that is coupled to the open rear surface 2216 of the main frame 221.

The rear frame 222 may be formed based on a plastic injection molding method, to have a planar shape corresponding to the shape of the open rear surface 2216 of the main frame 221.

A front surface 2221a of a plate body 2221 constituting the entire outer shape of the rear frame 222 may define a closed accommodation space in the rear frame 222, together with the main frame 221. In the closed accommodation space, a blower module 260, a plurality of camera modules, and a control module 280 including a circuit board 281 and circuit components, and the like that are described hereinafter may be accommodated.

Further, a suction duct 264 of the blower module 260 is attached to the front surface 2221a of the plate body 2221, and a suction flow path ACT through which external air is drawn may be formed on the front surface 2221a of the plate body 2221, together with the blower module 260. As illustrated in FIG. 10, a plurality of guide ribs 2221r for guiding movement of external air drawn and preventing a leakage of the external air drawn may be integrally formed on the front surface 2221a of the plate body 2221.

Further, the rear frame 222 may have a shape that covers the front surface of the main body 21 and the front surface of the cavity 211 entirely.

Accordingly, the rear frame 222 formed based on a plastic injection molding method is not enough to block electromagnetic waves and high-temperature heat that are generated in the cavity 211 and delivered.

To this end, the door 22 of one embodiment comprises a shielding plate 230 for suppressing and minimizing delivery of electromagnetic waves and high-temperature heat generated in the cooking compartment 211a in the cavity 211 into the door 22.

The shielding plate 230 may have a shape that is assembled to the open front of the cavity 211, and may be formed in such a way that a metal plate capable of effectively blocking electromagnetic waves and high-temperature heat is pressed.

A forward protrusion surface 232 having a rectangular shape that is convex forward is formed in a central portion of the shielding plate 230. The forward protrusion surface 232 may be coupled in such a way that the forward protrusion surface 232 is inserted into a central opening 2222 formed at the rear frame 222.

An edge surface 231 formed at the outer side of the forward protrusion surface 232 is configured to directly surface-contact a rear surface 2221b of the rear frame 222, and a width of the edge surface 231 may be determined to the extent that a predetermined coupling strength is maintained. A plurality of fastening holes through a fastening means such as a bolt and the like passes and extends may be formed on the edge surface 231.

Additionally, a rearward protrusion surface 233 having a rectangular ring shape may be formed between the forward protrusion surface 232 and the edge surface 231 of the shielding plate 230. The rearward protrusion surface 233 is a portion inserted into and coupled to the open front surface of the cavity 211, and corresponds to a means of maintaining a sealed state of the cavity 211, with the door 22 closed.

Further, a rectangular ring-shaped fastening bracket 223 for fixing the shielding plate 230 to the rear frame 222 may be coupled to the rearward protrusion surface 233, as illustrated in FIG. 11. The fastening bracket 223 has a fastening hole 2231 that is formed in such a way that the fastening hole 2231 penetrates the fastening bracket 223 in the front-rear direction.

The forward protrusion surface 232 may have a penetration hole 2321 that is open in the front-rear direction (F-R direction) of the shielding plate 230. The penetration hole 2321 is used to ensure a visual field of a cooking compartment camera 2731 described hereinafter.

Further, a heat insulation glass 235 may be disposed at the rear of the penetration hole 2321, and minimizes delivery of heat in the cooking compartment 211a, while ensuring a visual field of the cooking compartment camera 2731, as illustrated.

Further, a shielding bracket 234 for blocking electromagnetic waves delivered to the cooking compartment camera 2731 may be disposed at the front of the penetration hole 2321. The shielding bracket 234 may be made of a metallic material capable of blocking electromagnetic waves, like the shielding plate 230. Preferably, the shielding bracket 234 may be made of a material that has a higher electromagnetic wave shielding rate than the shielding plate 230, to improve the effect of shielding electromagnetic waves. Further, as illustrated, the shielding bracket 234 may have a camera hole 2341h that is open toward the cooking compartment 211a, and the camera hole 2341h may be provided at a forward protrusion part 2341 for forming a visual field.

Further, a join surface 2343 for enhancing fastening strength to the shielding plate 230 may be provided at the shielding bracket 234, in the form of a flange.

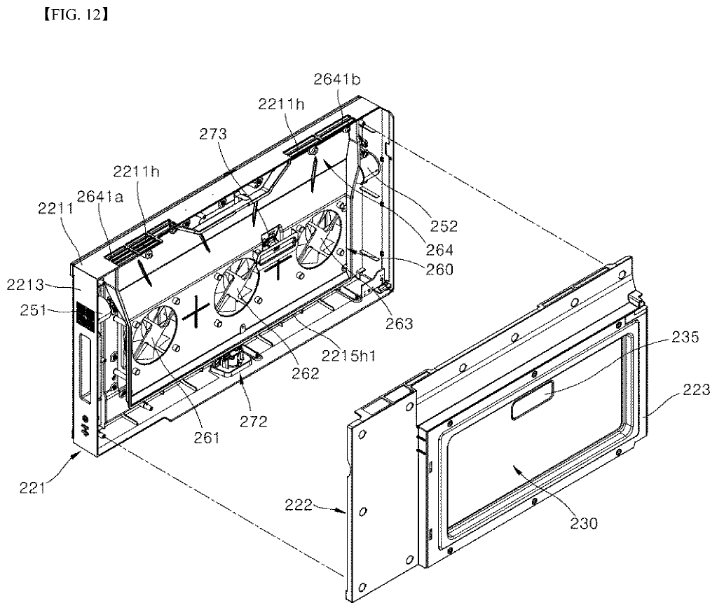

As illustrated in FIG. 12, an accommodation part 2223 for accommodating the shielding plate may be formed at the rear surface 2221b of the rear frame 222. The accommodation part 2223 may be formed in an accommodation wall 2224 protruding rearward from the rear surface 2221b of the rear frame 222.

The accommodation wall 2224 may have a size large enough to accommodate the shielding plate 230 entirely.

As the shielding plate 230 is disposed in the accommodation part 2223 and then fastened completely with the fastening bracket 223, a fastening structure in which the edge surface 231 of the shielding plate 230 is fixed and supported, in a state of being inserted between the fastening bracket 223 and the rear surface 2221b of the rear frame 222, may be achieved.

Additionally, a protrusion surface 2221c that is convex forward may be provided at the upper side of the central opening 2222 of the rear frame 222. The protrusion surface 2221c forms a space into which external air to flow into the main body is drawn, together with the small width surface of the main frame 221 described above.

The door 22 of one embodiment may be further provided with a blower module 260 drawing external air into the door 22 through the inhale opening 2211h of the main frame 221 and generating the airflow the external air.

As illustrated in FIGS. 10 to 12, the blower module 260 may be disposed in an accommodation space between the main frame 221 and the rear frame 222.

The blower module 260 may comprise a suction duct 264 forming a suction flow path AC1 of the external air drawn into the door 22.

The suction duct 264 may have a rear surface that is open entirely, and may be shaped into a box having a [symbol] -shaped cross section to have the suction flow path AC1 therein.

The open rear surface of the suction duct 264 is coupled and fixed to the front surface 2221a of the rear fame 222 described above, along the edge wall 2643. By doing so, the inner surface of the suction duct 264 and the front surface 2221a of the rear frame 222 may form a portion of a door air flow path AC in which external air flows, together, and the portion may be referred to as a suctioned air flow path.

To minimize an amount of heat delivered from the shielding plate 230 into the door 22, the suction duct 264 may be disposed to cover the front surface of the shielding plate 230 at least partially. Preferably, the suction duct may be disposed to cover at least the forward protrusion surface 232 of the shielding plate 230 entirely.

To this end, a left-right width of the suction duct 264, as illustrated, is greater than a left-right width of the open part of the rear frame 222 and a left-right width of the forward protrusion surface 232 of the shielding plate 230.

The suction duct 264 may comprise a first duct body 2641 and a second duct body 2642 that are distinguishable in the up-down direction.

The upper surface of the first duct body 2641 is open to form a first inlet 2641a and a second inlet 2641b, and the suction flow path AC1 divided into the first inlet 2641a and the second inlet 2641b has a Y shape in which the first inlet 2641a and the second inlet 2641b are combined toward the lower sides thereof. As described above, the front camera module 271 may be disposed between the first inlet 2641a and the second inlet 2641b. Additionally, each of the first inlet 2641a and the second inlet 2641b are disposed to directly connect to the inhale opening 2211h of the main frame 221, to improve suction efficiency.

At this time, to ensure a sufficient flow rate of suctioned air, a cross section of the first duct body 2641 decreases gradually further downward. Conversely, a flow path cross section at the first inlet 2641a side and the second inlet 2641b side are formed to be maximized.

Further, the second duct body 2642 connects to the lower side of the first duct body 2641. The second duct body 2642 may be integrally formed at the first duct body 2641, based on plastic injection molding.

Unlike the first duct body 2641, the second duct body 2642 may be shaped into a box the flow path cross section of which remains constant approximately.

Further, the flow path cross section of the second duct body 2642 remains less than the flow path cross section of the first duct body 2641. Accordingly, a flow velocity of the airflow of external air increases gradually from the first duct body 2641 to the second duct body 2642. As a result, efficiency of heat absorption into the shielding plate 230 may increase further toward the second duct body 2642.

Further, a camera installation surface 2644 may be provided on the inner surface of the suction duct 264. The above-described cooking compartment camera module 273 may be disposed and supported on the camera installation surface 2644.

That is, the cooking compartment camera module 273 is exposed directly to the airflow of external air flowing as well as being disposed directly in the suction flow path AC1. By doing so, efficiency of cooling the cooking compartment camera module 273 that needs to be disposed near the cavity 211 to photograph the inside of the cooking compartment 211a may be maximized, such that thermal damage to the cooking compartment camera module 273 is minimized.

Further, a plurality of fastening bosses 2645 protruding toward the rear frame 222 may be formed on the inner surfaces of the first duct body 2641 and the second duct body 2642. A fastening hole 2221h formed in such a way that the fastening hole penetrates the rear frame 222 is formed in positions corresponding to the positions of the fastening bosses 2645 of the first duct body 2641 and the second duct body 2642. The fastening boss 2645 and the fastening hole 2221h may be firmly coupled through a fastening means such as a bolt and the like.

Further, the second duct body 2642 may have at least one outlet 2642h on the front surface thereof. In an embodiment described, a total of three outlets 2642h is provided, for example. The number of the outlets is not limited, but hereinafter, an embodiment with a total of three outlets 2642h is described.

Each of the outlets 2642h may be shaped into a circular hole having the same diameter, and all the outlets are open toward the front surface 2215 of the main frame 221.

Further, an air blowing fan suctioning external air and forming the airflow of the external air may be disposed at the front of each outlet 2642h.

In the embodiment illustrated, an air blowing fan disposed at a left outlet may be referred to as a first air blowing fan 261, an air blowing fan disposed at a central outlet may be referred as a second air blowing fan 262, and an air blowing fan disposed at a right outlet may be referred to as a third air blowing fan 263.

An axial flow fan having the same air blowing capacity is applicable to all the first air blowing fan to the third air blowing fan 261, 262, 263. Accordingly, external air suctioned from the rears of the first air blowing fan to the third air blowing fan 261, 262, 263 may be discharged forward, specifically, toward the front surface 2215 of the main frame 221. Though not illustrated, an electric motor for driving the first air blowing fan to the third air blowing fan 261, 262, 263 may be provided respectively.

External air having passed through the first air blowing fan to the third air blowing fan 261, 262, 263 flows through an inner flow path formed between the blower module 260 and the main frame 221, in the door 22. As described above, the airflow of external air cools the display module 240, the front camera module 271, the lower camera module 272 and other electrical components while flowing along the inner flow path AC2 and then is discharged outward through the first exhaust opening 2215h1, the second exhaust opening 2215h2 and the third exhaust opening 2214h that are described above.

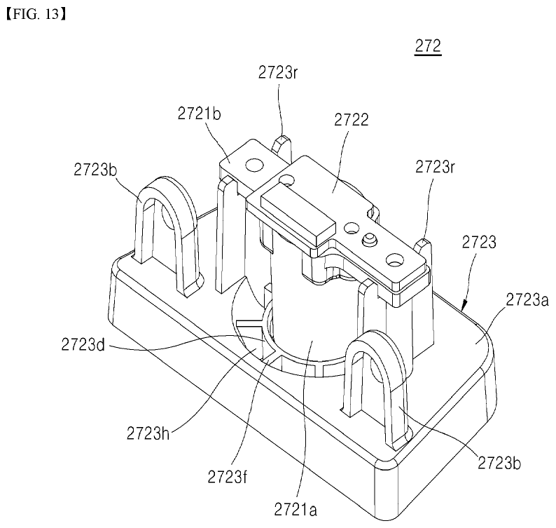

FIG. 13 shows the lower camera module 272 disposed at the third exhaust opening 2214h among the camera modules.

FIG. 13 shows the lower camera module 272 comprising a camera main body 2721a that photographs the downward direction of the door 22, a circuit board 2722 that is coupled to the camera main body 2721a and processes an image signal, and a camera holder that supports the camera main body 2721a, for example.

However, the embodiment in the present disclosure is not limited, and a configuration in which the camera main body 2721a is directly installed and supported in the lower surface 2214 of the main frame 221 is applicable, and at this time, a structure supporting the camera main body 2721a may be provided around the third exhaust opening 2214h formed on the lower surface 2214 of the main frame 221. The embodiment in the present invention is not limited, but the camera main body 2721a fixed to the main frame 221 through a separate camera holder, for example.

As illustrated, the camera holder comprises a main body plate 2723a having a planar shape.

The lower surface of the main body plate 2723a is surface-contacted and supported on the inner surface of the lower surface 2214 of the main frame 221, and has a shape corresponding to the shape of the inner surface of the lower surface 2241 of the main frame 221.

At least one fastening tab 2723b may be formed on the upper surface of the main body plate 2723a in such a way that the fastening tab protrudes, and the fastening tab 2723b has a fastening hole. The main body plate 2723a may be fixed to the main frame 221 with a fastening means such as a bolt and the like that passes and extends through the fastening hole.

Additionally, a support rib 2723b may be formed on the upper surface of the main body plate 2723a in such a way that the support rib 2723b protrudes. A fastening flange 2721b of the camera main body 2721a may be coupled to the upper end of the support rib 2723b, and the support rib and the fastening flange 2721b may be fastened to each other with a bolt and the like.

Further, a vent hole 2723h may be formed between the support ribs 2723b, in a central portion of the main body plate 2723a, and a support ring 2723d may be formed inside the vent hole 2723h.

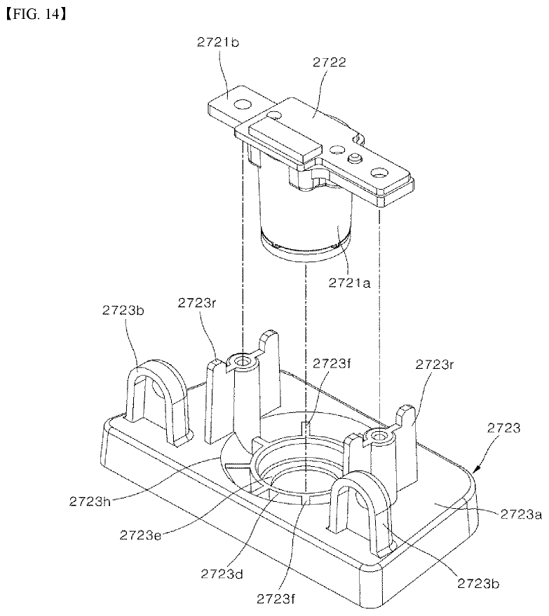

As illustrated in FIG. 14, the vent hole 2723h may be provided as a nozzle shaped into a truncated cone the cross section of which decreases gradually in the downward direction. Accordingly, a flow velocity of the airflow of external air passing through the vent hole 2723h may increase gradually. Further, the airflow of external air passing through the third exhaust opening 2214h has directionality facing the center of the third exhaust opening 2214h, increasing the effect of preventing contamination.

The support ring 2723d may have a step part 2723e to support the front end of the camera main body 2721a and prevent the front end of the camera main body 2721a from escaping.

The inner circumferential surface of the vent hole 2723h and the outer circumferential surface of the support ring 2723d are coupled to each other through a plurality of connection ribs 2723f. Preferably, the plurality of connection ribs 2723f may be disposed at regular intervals. Accordingly, the airflow of external air may move between the vent hole 2723h and the support ring 2723d.

The third exhaust opening 2214h of the main frame 221 is disposed right under the vent hole 2723h. Preferably, the vent hole 2723h and the third exhaust opening 2214h may be formed in such a way that the vent hole 2723h and the third exhaust opening 2214h are approximately concentric.

Accordingly, the airflow of external air to be discharged to the third exhaust opening 2214h passes over the camera main body 2721a and the circuit board 2722 of the lower camera module 272 and then passes through the vent hole 2723h. That is, the camera main body 2721a and the circuit board 2722 are exposed to the airflow of the external air to be discharged to the third exhaust opening 2214h.

With the structure, the airflow of the external air to be discharged to the third exhaust opening 2214h may be used to cool the lower camera module 272 primarily, and after being discharged to the third exhaust opening 2214h, used as an airflow for an air curtain preventing contamination of the lower camera secondarily.

### [Door Air Flow Path of Door of Microwave Oven Doubling as Hood]

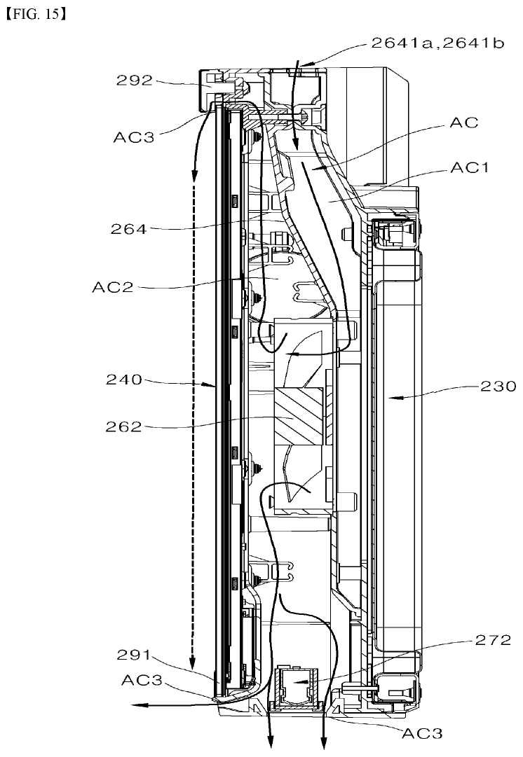

Hereinafter, a door air flow path AC formed at the door 22 of one embodiment is described with reference to FIGS. 15 to 17.

As described above, the door 22 of one embodiment is provided with a door air flow path AC in which the airflow of external air flows.

The door air flow path AC comprises a suction flow path AC1 into which external air is drawn.

As described above, the suction flow path AC1 may be formed between the suction duct 263 and the rear frame 222, and partially formed between the suction duct 264 and the shielding plate 230.

External air moves downward in the drawing along the suction flow path AC1 starting from the first inlet 2641a and the second inlet 2641b of the suction duct 264, and while moving downward, a flow velocity of the airflow of the external air increases gradually.

The cooking compartment camera module 273 and the rearward protrusion surface 233 of the shielding plate 230 are exposed directly to the suction flow path AC1. Accordingly, while the airflow of external air flows, the cooking compartment camera module 273 and the rearward protrusion surface 233 of the shielding plate 230 may cool effectively.

As the airflow of external air flowing in the suction flow path ACT arrives at the outlet of the suction duct 264, the air flow is blown forward through the first air blowing fan to the third air blowing fan 261, 262, 263, and preferably, blown toward the rear surface of the display module 240.

At this time, the direction of the airflow of the external air is changed to have directionality facing the forward direction, while passing over the air blowing fans 261, 262, 263.

Additionally, the airflow of the external air blown toward the rear surface of the display module 240 flows, while being dispersed evenly to the inner flow path AC2 formed between the suction duct 264 and the front surface 2215 of the main frame 221. That is, in the inner flow path AC2, a portion of the airflow of the external air moves down toward the first exhaust opening 2215h1 and the third exhaust opening 2214h, while a portion of the airflow of the external air moves up toward the second exhaust opening 2215h2.

The airflow of the external air that flows up and down while being dispersed to the inner flow path AC2 as described above cools electrical components such as the rear surface of the display module 240, the circuit board 281 constituting the control module 280 and the front camera module 271 and the like, which are exposed to the airflow of the external air.

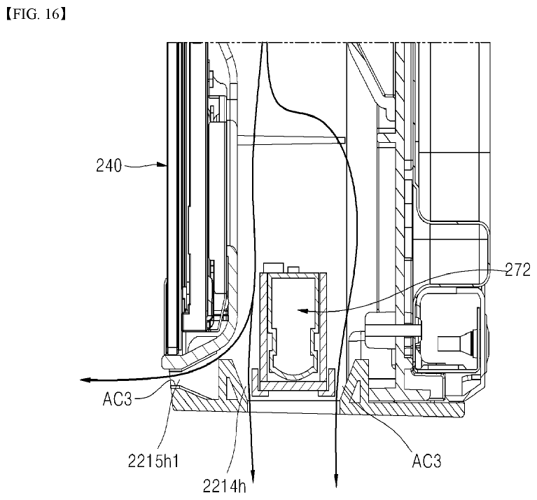

As illustrated in FIG. 16, a portion of the airflow of external air flowing downward passes through the first exhaust opening 2215h1 and is discharged forward to the outside, and the remaining portion is discharged downward to the outside through the third exhaust opening 2214h.

As described above, the first exhaust opening 2215h1 may be formed on the front surface of the door 22 in a slit shape that extends linearly along the left-right direction. At this time, an exhaust flow path AC3 having a nozzle structure where a flow path cross section decreases gradually while the airflow of the external air proceeds may be formed in the first exhaust opening 2215h1. The airflow of the external air may be discharged from the first exhaust opening 2215h1 in a way that a flow velocity increases gradually while the airflow of the external air proceeds along the exhaust flow path AC3.

Additionally, the exhaust flow path AC3 in the first exhaust opening 2215h1 may be manufactured such that the airflow of the external air has directionality mostly facing forward. By doing so, the airflow of the external air discharged to the first exhaust opening 2215h1 may act as an air curtain that prevents and suppresses movement of contaminated air to the front surface of the display module 240, i.e., the front surface of the door 22.

However, contaminated air moving up needs to change a direction of the airflow of the external air discharged to the first exhaust opening 2215h1, depending on a flow rate and a flow velocity. For example, in the case where cooking is performed at a maximum capacity in the lower cooktop, an excessive amount of contaminated air may be generated.

At this time, the position of the first guard plate 291 disposed at the front side of the first exhaust opening 2215h1 moves downward, a direction of the airflow of the external air discharged to the first exhaust opening 2215h1 may be adjusted to face further downward. Specifically, the airflow of the external air may change in a way that like the second guard plate 292 described hereinafter, the first guard plate 291 moves to cover the front of the first exhaust opening 2215h1 partially.

Further, external air passes through the vent hole 2723h having a nozzle structure of a truncated cone shape the cross section of which decreases gradually further downward, before passing through the third exhaust opening 2214h.

As illustrated, the airflow of the external air discharged through the exhaust flow path AC3 having a nozzle structure of a truncated cone shape may be discharged, while having directionality collected on a straight line extending the central line of the third exhaust opening 2214h and the lower camera module 272. Accordingly, prevention of contamination of a lens formed in the lower end portion of the camera main body 2721a may be maximized.

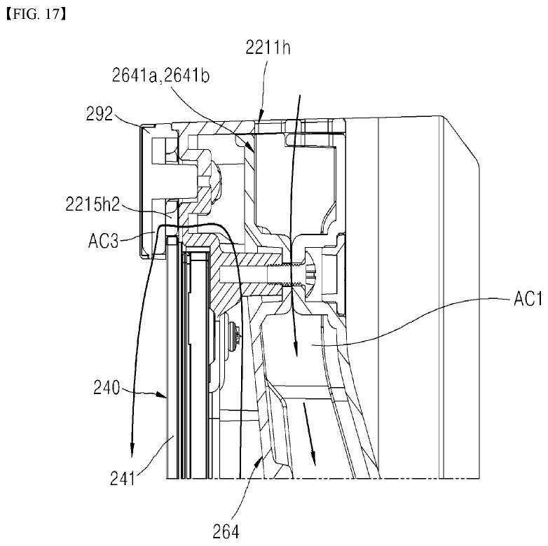

As illustrated in FIG. 17, a portion of the airflow of external air moving up passes through the second exhaust opening 2215h2 and is discharged forward to the outside. Preferably, a portion of the airflow of the external air cools the front camera module 271 and then is discharged to the second exhaust opening 2215h2, before passing through the second exhaust opening 2215h2.

The second exhaust opening 2215h2, as described above, may be formed on the front surface of the door 22, in a slit shape that extends linearly along the left-right direction.

The exhaust flow path AC3 in the second exhaust opening 2215h2 may be manufactured in a way that the airflow of external air has directionality mostly facing forward.

At this time, a direction of the airflow of the external air discharged to the second exhaust opening 2215h2 is changed by the second guard plate 292 disposed at the front of the front camera module 271.

The second guard plate 292, as illustrated in FIG. 17, is disposed at the front of the second exhaust opening 2215h2 to cover the front of the second exhaust opening 2215h2 at least partially.

Accordingly, the exhaust flow path AC3 formed between the rear surface of the second guard plate 292 and the second exhaust opening 2215h2 changes the airflow of external air downward.

Specifically, the airflow of the external air, the direction of which is changed through the exhaust flow path AC3, moves along the surface of the touch plate 241 of the display module 240 and covers the surface of the touch plate 241 at least partially.

By doing so, the airflow of external air discharged serves an air curtain that covers the front surface of the touch plate 241.

As described above, the front surface of the door 22, i.e., the surface of the touch plate 241, in one embodiment, produce the effect of preventing contamination caused by contaminated air doubly, by using the airflow of external air discharged to the first exhaust opening 2215h1 and the airflow of external air discharged to the second exhaust opening 2215h2.

The embodiments are described above with reference to a number of illustrative embodiments thereof. However, embodiments are not limited to the embodiments and drawings set forth herein, and numerous other modifications and embodiments can be drawn by one skilled in the art within the technical scope of the disclosure. Further, predictable effects based on the configurations in the disclosure are to be included within the range of the disclosure though not explicitly described in the description of the embodiment.

1.-21. (canceled)

22. A cooking appliance, comprising:
a main body including:
a cavity, the cavity including:
a cooking compartment; and
an open front surface; and
an air flow path configured to:
suction contaminated air including contaminants, and
flow the contaminated air around the cavity; and
a door rotatably attached to a front surface of the main body, the door including a blower module configured to draw external air into the door through an upper surface of the door.

23. The cooking appliance of claim 22, wherein the contaminated air is suctioned into a lower surface of the main body and is discharged outwardly from the front surface of the main body above the cooking cavity.

24. The cooking appliance of claim 23, wherein the door further includes:
a main frame having an opened rear surface; and
a rear frame coupled to the rear surface of the main frame, the rear frame having a planar shape,
wherein the blower module is fixed to the rear frame, and
wherein the blower module is positioned between the main frame and the rear frame.

25. The cooking appliance of claim 24, wherein the blower module includes:
a suction duct including:
a plurality of inlets configured to draw in external air; and
an air flow path in which the external air flows; and
an air blowing fan supported in the suction duct, the air blowing fan configured to suction the external air and generate the air flow of the external air, and
wherein the suction duct is fixed to a front surface of the rear frame.

26. The cooking appliance of claim 25, wherein the door further includes a shielding plate fixed to the rear frame,
wherein the suction duct at least partially covers a front surface of the shielding plate, and
wherein a portion of the shielding plate is exposed to the air flow of the external air in the air flow path of the suction duct.

27. The cooking appliance of claim 25, wherein the suction duct is provided with an outlet discharging the external air drawn through the plurality of inlets, and
wherein the outlet is open towards a front surface of the main frame.

28. The cooking appliance of claim 27, wherein the door is provided with a cooking compartment camera configured to capture an image of the cooking compartment, and
wherein the cooking compartment camera is disposed in the air flow path of the suction duct.

29. The cooking appliance of claim 25, wherein the plurality of inlets includes:
a first inlet; and
a second inlet spaced from the first inlet in a left-right direction, and
wherein the door includes a front camera disposed between the first inlet and the second inlet, the front camera being configured to photograph a front of the door.

30. The cooking appliance of claim 29, wherein the front camera is disposed on a front surface of the main frame, and
wherein the front camera is exposed to the air flow of the external air.

31. The cooking appliance of claim 29, wherein the door includes a display module, the display module being disposed at a front surface of the main frame, and
wherein a rear surface of the display module is exposed to flow of the external air through an open part of the main frame.

32. The cooking appliance of claim 31, wherein the door further includes a first exhaust opening formed at a lower side of the display module, the exhaust opening being configured to discharge the air flow of external air.

33. The cooking appliance of claim 32, wherein the first exhaust opening is formed under the front surface of the main frame, the first exhaust opening extending along the left-right direction, and
wherein a length of the first exhaust opening in the left-right direction is greater than a length of the display module in the left-right direction.

34. The cooking appliance of claim 31, wherein the door further includes a second exhaust opening formed at an upper side of the display module, the second exhaust opening being configured to discharge the air flow of external air, and
wherein the air flow of the external air discharged through the second exhaust opening is configured to form an air curtain to prevent movement of the contaminated air towards a front surface of the door.

35. The cooking appliance of claim 34, wherein the door further includes a guard plate disposed in front of the second exhaust opening, and
wherein the guard plate is configured to change a direction of the air discharged from the second exhaust opening, the direction of the air discharged from the second exhaust opening being downward and parallel with the display module.

36. The cooking appliance of claim 35, wherein the front camera is disposed at a rear surface of the guard plate, and
wherein the front camera is exposed to the air flow of the external air to be discharged to the second exhaust opening.

37. The cooking appliance of claim 31, wherein the door further includes a lower camera photographing a downward direction of the door, and
wherein the lower camera is supported by a lower surface of the main frame.

38. The cooking appliance of claim 37, wherein the door further includes a third exhaust opening formed at a lower side of the lower camera, the third exhaust opening being configured to outwardly discharge the air flow of the external air, and
wherein the lower camera is exposed to the air flow of the external air to be discharged to the third exhaust opening.

39. The cooking appliance of claim 38, wherein the door further includes a camera holder supporting the lower camera,
wherein the camera holder is formed separate from the main frame, and
wherein the camera holder is fixed to the lower surface of the main frame.

40. The cooking appliance of claim 39, wherein the camera holder includes a through hole through which the air flow of the external air passes, and
wherein the air flow of the external air having passed through the through hole is discharged to the third exhaust opening.

41. A cooking appliance, comprising:
a main body including:
a cavity, the cavity including a cooking compartment;
an air flow path configured to:
suction contaminated air including contaminants, and
flow the contaminated air around a rear surface of the cavity; and
a door rotatably attached to the main body, the door including:
a cooking compartment camera configured to capture an image of the cooking compartment;
a suction duct including:
an inlet configured to draw in external air; and
an air flow path in which the external air flows; and
an air blowing fan supported in the suction duct, the air blowing fan configured to suction the external air and generate the air flow of the external air around the cooking compartment camera.
